(19) United States
(12) Patent Application Publication
(10) Pub. No.: US 2026/0255107 A1
(43) Pub. Date: Aug. 27, 2026

(54) VOICE COIL ASSEMBLY INCLUDING THERMISTOR

(71) Applicant: Swarm Holdings LLC, Salt Lake City, UT (US)

(72) Inventors: Greg McKinney, Brigham City, UT (US); Jonathan Neil Hart, Salt Lake City, UT (US)

(73) Assignee: Swarm Holdings LLC, Salt Lake City, UT (US)

(21) Appl. No.: 19/065,872

(22) Filed: Feb. 27, 2025

(51) Int. Cl. H04R 9/04; H04R 9/06

(52) U.S. Cl. CPC H04R 9/04; H04R 9/06

(57) ABSTRACT

A voice coil assembly. There is: a voice coil including voice coil winding; a glass encapsulated thermistor, coupled to the voice coil winding, in direct thermal contact with the voice coil winding, and not electrically coupled to the voice coil; and adhesive, disposed between the voice coil winding and the glass encapsulated thermistor, physically and thermally coupling the glass encapsulated thermistor to the voice coil winding.

### BACKGROUND OF THE INVENTION

### Field of the Invention

The present invention relates to voice coil assemblies, specifically voice coil assemblies for measuring voice coil temperatures.

### Description of the Related Art

In the related art, it has been known to use voice coils to convert electrical into mechanical energy. Voice coils generally consist of a former, collar, and winding. A voice coil of a speaker is the coil of wire attached to the apex of a loudspeaker cone. A voice coil provides the motive force to the cone by a reaction of a magnetic field to the current passing through it. This activity generates heat within the system including heat in the voice coil.

One thing to be considered is how well the speaker dissipates heat. Only a small fraction of the electrical energy that goes into a speaker is transformed into sound. Most of the electrical energy becomes heat that can damage a speaker or hurt sound quality if the speaker is subjected to heat beyond its operating capacity. Heat can also change the performance of the speaker because the electrical resistance of typical voice coil wire materials changes with temperature, and thus impart a temperature variant load to the amplifier, leading to effects like power compression.

Accordingly, there are systems for monitoring heat within a speaker. In particular, heat buildup within the voice coil of the speaker can be especially problematic as the voice coil is especially affected by significant change in temperature (generally temperatures above 150 degrees Celsius begin to cause thermal breakdown in insulation and adhesive, and even in damaging the coil). However, it is especially difficult to measure heat within the voice coil because it is a highly sensitive electronic component and simultaneously a highly sensitive mechanical component. Accordingly, temperature measurements of voice coils are done indirectly.

Often, the temperature of a voice coil can be monitored without using any sensor by measuring the direct current resistance and considering the material properties of the voice coil. The direct current resistance corresponds with the electrical impedance at very low frequencies. Another method is to estimate the temperature using an adaptive filter to derive the impedance of the loudspeaker. A curve fitting is performed on the loudspeaker during normal use and that normal curve is then used as a basis from which to estimate the temperature. Still another indirect method is to track power dissipation in order to estimate heat buildup in relation to expected heat dissipation ability of the speaker. Still another technique is to use ultrasonic thermometry (pilot tones) to extract temperature information from the wires of the voice coil. The reason that indirect methods are utilized is that direct methods have negative effects on the performance of the speaker. For example, generally both NTC and PTC thermistors include ferromagnetic materials that distort voice coil operation. Further, thermometers are bulky and expensive and have a slower response to temperature change.

In extreme applications (which voice coil applications are not), glass encapsulated thermistors have been developed because: 1) typical thermistors are poorly suited to high temperatures (up to 350 degrees Celsius), and 2) typical thermistors are easily damaged by harsh environments (crushing, impact, chemicals, moisture, and corrosion). These are generally used in industrial equipment and automotive engine control units, as well as self-heating appliances like ovens and refrigerators. Glass encapsulated thermistors specifically allow for direct temperature sensing by coupling directly to a monitored device. Glass encapsulated thermistors generally include glass-coated bead thermistors on fine diameter platinum alloy lead wires. The special thin glass coatings provide a hermetic seal, making these thermistors unaffected by sever environmental exposures. Accordingly, glass encapsulated thermistors are specialized sensors that have previously been utilized for extracting temperature information in extreme environments (where there is exposure to moisture, chemicals, extreme temperatures, etc.).

Some improvements have been made in the field. Examples of references related to the present invention are described below in their own words, and the supporting teachings of each reference are incorporated by reference herein:

German Patent No.: DE102016101863, issued to Alfons Dehe and Ulrich Krumbein, discloses a converter (100) comprising: a micro-engineered element integrated on a single die (102; 102a-e; 500; 520), wherein the micro-engineered element comprises an acoustic transducer and a temperature sensor (120; 157; 182; 508), and an interface integrated circuit coupled to the microfabricated element and electrically coupled to the acoustic transducer and the temperature sensor (120; 157; 182; 508), wherein the temperature sensor comprises a sensing plate selected from a backplate (524), a first backplate (114), a second backplate (118), or a diaphragm (116; 506; 528) of the acoustic transducer, the sensing plate having contacts (170, 172, 174, 178) for measuring a sheet resistance of the sensing plate.

United Kingdom Patent No.: GB2526881, issued to Lesso, discloses this application relates to methods and apparatus for determining the temperature of a voice coil of a loudspeaker 204, for instance as part of a system 208 for protecting the loudspeaker from overheating. The method comprises driving the voice coil with signal components at first and second frequencies, wherein the first frequency (fH) is higher than the second frequency (fL), and determining first and second indications of current ICM and voltage VCM of the voice coil at said first and second frequencies respectively. The method involves determining an estimated ratio value using the first and second indications of current and voltage, wherein said estimated ratio value corresponds to a ratio between a value based on the resistance of the voice coil and a value based on the inductance of the voice coil. The temperature of the voice coil is then determined based on said estimated ratio value and at least one reference value. An impedance extraction module 210 may extract values for the impedance at the first and second frequencies respectively ZH, ZL. In some embodiments a module 212 may determine estimated values of the resistance REM and inductance LEM of the voice coil which are used by temperature estimation block 214 to determine the temperature.

United Kingdom Patent No.: GB2563460, issued to Bjork et al., discloses methods and apparatus are disclosed for monitoring and/or determining the temperature of a voice coil of a loudspeaker, and in particular to methods and apparatus for protecting a speaker from overheating by estimating the temperature of the voice coil of the speaker.

U.S. Pat. No. 7,434,987, issued to Gustafson et al., discloses a method to detect helium leakage from a disk drive enclosure is disclosed and claimed. A measurement electrical current is passed through a temperature sensor disposed within the disk drive enclosure. A reference electrical resistance corresponds to a reference temperature of the temperature sensor. A heating electrical current is passed through the temperature sensor. A heated electrical resistance of the temperature sensor, corresponding to a heated temperature of the temperature sensor that exceeds the reference temperature by at least 5° C., is determined. A value that corresponds to a quantity of helium within the disk drive enclosure is determined based on the reference electrical resistance and heated electrical resistance.

U.S. Pat. No. 10,149,050, issued to Lesso, discloses this application relates to methods and apparatus for determining the temperature of a voice coil of a loudspeaker (204), for instance as part of a system (208) for protecting the loudspeaker from overheating. The method comprises driving the voice coil with signal components at first and second frequencies, wherein the first frequency (fy) is higher than the second frequency (f2), and determining first and second indications of current (ICM) and voltage (VCM) of the voice coil at said first and second frequencies respectively. The method involves determining an estimated ratio value using the first and second indications of current and voltage, wherein said estimated ratio value corresponds to a ratio between a value based on the resistance of the voice coil and a value based on the inductance of the voice coil. The temperature of the voice coil is then determined based on said estimated ratio value and at least one reference value. An impedance extraction module (210) may extract values for the impedance at the first and second frequencies respectively (ZH, ZL). In dome embodiments a module (212) may determine estimated values of the resistance (REM) and inductance (LEM) of the voice coil which are used by temperature estimation block (214) to determine temperature.

U.S. Pat. No. 10,582,300, issued to Bjork et al., discloses methods and apparatus for estimating a temperature of an electromechanical transducer. The method comprising receiving an audio signal (901); providing an output signal to the electromechanical transducer, based on the audio signal (902); and determining whether a first magnitude of the audio signal in a first frequency band is above a magnitude threshold (903). In response to the first magnitude being above or equal to the magnitude threshold, calculating a first impedance of the electromechanical transducer based on measurements of a first voltage and a first current of the electromechanical transducer within the first frequency band (905), and estimating the temperature of the electromechanical transducer based on the first impedance (907). In response to the first magnitude being below the magnitude threshold, inserting a pilot tone into the audio signal (909), wherein the pilot tone is at a pilot tone frequency, calculating a second impedance of the electromechanical transducer based on measurements of a second voltage and a second current of the electromechanical transducer at the pilot tone frequency (911), and estimating the temperature of the electromechanical transducer based on the second impedance (913).

The inventions heretofore known suffer from a number of disadvantages which include: not providing accurate measurements, being difficult to manufacture, being expensive to manufacture, disrupting sound, being bulky, not providing additional power, and not providing temperature measurements beyond a desired range.

What is needed is a voice coil assembly that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available voice coils. Accordingly, the present invention has been developed to provide an voice coil assembly.

In one embodiment of the invention, there is a voice coil assembly that may comprise: a voice coil that may include voice coil winding; a glass encapsulated thermistor, that may be coupled to the voice coil winding, may be in direct thermal contact with the voice coil winding, and/or may not be electrically coupled to the voice coil; and/or adhesive, that may be disposed between the voice coil winding and/or the glass encapsulated thermistor, that may physically and/or thermally couple the glass encapsulated thermistor to the voice coil winding.

In other embodiments, the glass encapsulated thermistor may be coupled to a top of the voice coil winding. The glass encapsulated thermistor may include a lead wire and/or wherein the lead wire may consist of non-ferromagnetic material. The voice coil assembly may further comprise a voice coil former that may be interior to the voice coil winding, wherein the glass encapsulated thermistor may be disposed on an exterior surface of the voice coil former and/or may be adjacent to the voice coil winding.

In further embodiments, the voice coil assembly may further comprise a counter-weight that may be disposed opposite to the glass encapsulated thermistor, such that the center of mass of the voice coil assembly may not be altered by the glass encapsulated thermistor. The voice coil assembly may further comprise tinsel leads that may be functionally coupled to lead wires of the glass encapsulated thermistor. The glass encapsulated thermistor may have an operating temperature range that may include between negative twenty degrees Celsius to two hundred and sixty degrees Celsius. The adhesive may be unitary with adhesive of the voice coil winding because during assembly the adhesive and the adhesive of the voice coil winding may be cured at the same time.

In another embodiment, there may be a voice coil assembly that may comprise: a voice coil that may include voice coil winding that may be disposed about a voice coil former; and/or a glass encapsulated thermistor, that may be coupled to the voice coil winding, may be in thermal contact with the voice coil winding, and/or may not be directly electrically coupled to the voice coil, wherein the glass encapsulated thermistor may include a lead wire and/or wherein the lead wire may consist of non-ferromagnetic material.

Yet, in further embodiments, the voice coil assembly may further comprise a thermally conductive strip that may be disposed between the glass encapsulated thermistor and/or the voice coil winding. The thermistor may include a single glass encapsulated bead that may be in direct thermal contact with the voice coil winding. The voice coil assembly may further comprise: a microcontroller that may be in signal communication with the glass encapsulated thermistor; and/or a power harvesting circuit that may be functionally coupled to the microcontroller, may be configured to capture and/or convert environmental energy into electrical energy and/or feed the electrical energy into the microcontroller.

Still, in one embodiment, there may be a voice coil assembly that may comprise: a speaker housing; a voice coil that may be disposed within the speaker housing; a glass encapsulated thermistor, that may be coupled to the voice coil, may be in direct thermal contact with the voice coil; a microcontroller that may be in signal communication with the glass encapsulated thermistor that may be disposed within the speaker housing; and/or a power harvesting circuit that may be functionally coupled to the microcontroller and/or may. be disposed within the speaker housing, may be configured to capture and/or convert environmental energy into electrical energy and/or feed the electrical energy into the microcontroller.

More, in embodiments, the power harvesting circuit may be electrically coupled to the voice coil. The microcontroller may include an output line that may not be electrically coupled to the voice coil. The microcontroller may include a wireless transmitter. The voice coil may have an intended frequency range and/or may further comprising a signal generating circuit that may be in communication with the microcontroller and/or may be electrically coupled to the voice coil, wherein the signal generating circuit may generate a signal representing temperature information and/or the signal may be outside of the intended frequency range.

Also, in one embodiment, there may be a voice coil assembly that may comprise: a voice coil winding; a glass encapsulated thermistor, that may be coupled to the voice coil winding, may be in direct thermal contact with the voice coil winding; an ohmmeter that may be functionally coupled to the glass encapsulated thermistor; and/or a signal generator that may be in communication with the ohmmeter and/or may be electrically coupled to the voice coil such that a signal generated thereby may be transmitted through the voice coil winding.

In additional embodiments, the voice coil assembly may further comprise a power harvesting circuit that may be functionally coupled to at least one of the ohmmeter and/or the signal generator, may be configured to capture and/or convert environmental energy into electrical energy and/or may feed the electrical energy thereinto. The signal generator may generate a signal with a carrier frequency that may be outside the frequency range of between about twenty hertz to twenty kilohertz. The voice coil assembly may further comprise a voice coil former that may be interior to the voice coil winding, wherein: the glass encapsulated thermistor may be disposed on an exterior surface of the voice coil former and/or may be adjacent to the voice coil winding; the glass encapsulated thermistor may be coupled to a top of the voice coil winding; and/or the glass encapsulated thermistor may include a lead wire and/or wherein the lead wire may consist of non-ferromagnetic material.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a magnified/close-up front perspective sectional view of a voice coil assembly, according to one embodiment of the invention;

FIG. 2 is a magnified/close-up side sectional view of a voice coil assembly, according to one embodiment of the invention;

FIG. 3 is a front perspective sectional view of a voice coil assembly, according to one embodiment of the invention;

FIG. 4 is a side sectional view of a voice coil assembly, according to one embodiment of the invention;

FIG. 5 is a magnified/close-up front perspective sectional view of a voice coil assembly, according to one embodiment of the invention;

FIG. 6A is a side sectional view of a voice coil of a voice coil assembly, according to one embodiment of the invention;

FIG. 6B is a side sectional view of a voice coil of a voice coil assembly, according to one embodiment of the invention;

FIG. 7 illustrates a circuit diagram of a voice coil assembly, according to one embodiment of the invention;

FIG. 8 illustrates a circuit diagram of a voice coil assembly, according to one embodiment of the invention; and

FIG. 9 illustrates a circuit diagram of a voice coil assembly, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

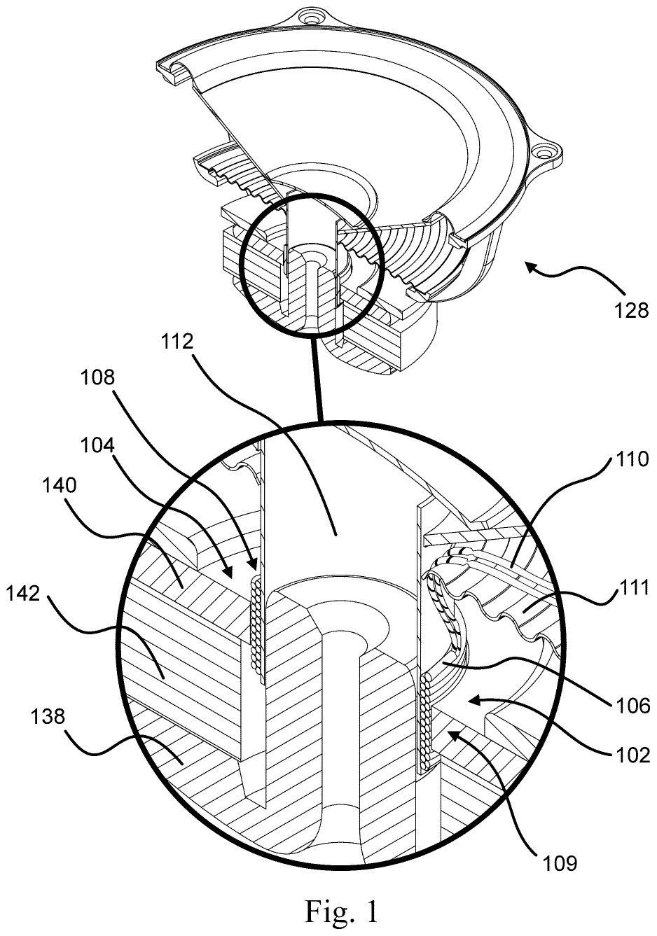

FIG. 1 illustrates a magnified/close-up front perspective sectional view of a voice coil assembly, according to one embodiment of the invention. As shown, the voice coil assembly includes a voice coil 102 with voice coil winding 104 wrapped about a former 112. A glass encapsulated thermistor 106 is coupled to the voice coil winding 104 at a top 108 of the voice coil winding 104. The glass encapsulated thermistor 106 also includes a lead wire 110, and the voice coil assembly is shown disposed within a speaker housing 128.

The illustrated voice coil 102 is a wire coil that conducts electric current. The voice coil 102 is generally comprised of a non-ferromagnetic (e.g., copper, aluminum, etc.) conducting wire. In a speaker, the voice coil 102 carries an electric signal, and when that electric signal goes through the voice coil, while the voice coil is in a magnetic flux gap, it generates a motive force that causes the voice coil assembly to move according to the signal thereby generating sound from the speaker cone. Accordingly, the voice coil 102 may be a coil of wire that drives a cone of a loudspeaker according to current flowing through it.

The illustrated voice coil winding 104 includes a coil of wire typically made form highly conductive metals such as copper, aluminum, or copper-clad aluminum. The winding 104 is coated with a thin layer of insulation. Generally, this is an enamel coating that prevents individual turns of the wire from shorting out with each other. A bonding adhesive is applied to the winding 104 to secure the wire to the former 112.

The illustrated glass encapsulated thermistor 106 is coupled to the top 108 voice coil winding 104, and in direct thermal contact with the voice coil winding 104 such that the glass encapsulated thermistor 106 is physically touching the voice coil winding 104 and heat may be directly transferred between them. The glass encapsulated thermistor 106 is generally a thermally sensitive resistor (e.g., PTC, NTC) that changes value with temperature. Accordingly, the glass encapsulated thermistor 106 can thereby make direct measurements of the temperature of the voice coil 102.

According to one embodiment of the invention, the illustrated glass encapsulated thermistor 106 comprises a single glass bead encapsulating a temperature sensitive resistive material (e.g., a metal oxide ceramic) connected to non-ferromagnetic lead wires (e.g., platinum or copper) and secured thereto with a bonding material. Advantageously, non-ferromagnetic lead wires do not engage with or disrupt a magnetic flux gap. The glass encapsulated thermistor 106 may be acquired from a thermistor producer such as, but not limited to: the DO-34 Standard Thermistor, by Littelfuse Inc., 8755 West Higgins Road Suite 500, Chicago, IL 60631; the DG103350 NTC Thermistor, by Ametherm Inc., 961 Fairview Drive, Carson City, NV 89701; and the SEN-00250 Thermistor 10K, by SparkFun Electronics, 6333 Dry Creek Parkway, Niwot, CO 80503, which are is incorporated by reference herein. However, it is also understood that the glass encapsulated thermistor 106 may have any number of glass beads, such as one, two, or six, for example. Further, it is understood that the glass encapsulated thermistor 106 may have an operating temperature range including between about negative twenty degrees Celsius to about two hundred and sixty degrees Celsius.

In the illustrated embodiment, the top 108 of the voice coil winding 104 may be a portion of the voice coil winding 104 that extends out and away from an air gap 109. The top 108 of the winding 104 is coupled to the glass encapsulated thermistor 106. Coupling to the top 108 of the voice coil winding 104 allows, encourages, and possibly even enforces the lead wire(s) to extend away from the voice coil 102 along a spider 111.

Additionally, by coupling the glass encapsulated thermistor 106 to the top 108 of the winding 104, the thermistor 106 is protected against mechanical damage in the event that the voice coil 102 is over energized, thus causing it to make physical contact with a back plate 138. Also, the heat generated in the voice coil 102 tends to more efficiently radiate to materials with high thermal conductivity like the back plate 138, the magnet 142, and the top plate 140. Since the top 108 of the voice coil winding 104 is outside of the flux gap 109, and not in direct radiant contact with the back plate 138, the magnet 142, and the top plate 140, it tends to retain more heat than a middle and a bottom, and thus tends to have a higher temperature. By locating the glass encapsulated thermistor 106 near the top 108, it is possible to accurately measure the highest temperature on the voice coil 102. Finally, by locating the glass encapsulated thermistor 106 on the top 108 of the voice coil winding 104, instead of on a side, the glass encapsulated thermistor 106 does not protrude any further from the voice coil former 112 than the voice coil winding 104, and thus does not intrude any further into the flux gap 109 (which would reduce the system clearances, cause rubbing, vibration, contact, failure, explosion, etc.)

Also illustrated, the thermistor lead wires 110 are functionally coupled to the glass encapsulated thermistor 106 opposite the top 108 of the voice coil winding 104, such that resistance within the thermistor 106 may be measured remote from the thermistor 106. The thermistor lead wires 110 may be non-ferromagnetic, such as a coated copper wire, a tinned copper wire or another electrically conductive wire used to connect two locations (such as the thermistor 106 and an external circuit) electrically. The thermistor lead wires 110 are shown disposed along the spider 111 of the speaker housing 128 but may be disposed anywhere along the speaker housing 128 that supports and protects the thermistor lead wires 110, The illustrated voice coil assembly is disposed within the speaker housing 128. It is understood that the speaker housing 128 may include a spider/speaker basket 111 and frame for containing and/or supporting the voice coil assembly. In one embodiment, the speaker housing 128 may be a loudspeaker enclosure or a loudspeaker cabinet in which speaker drivers and associated electronic hardware, such as crossover circuits and, in some cases, power amplifiers, may be mounted.

In operation, a glass encapsulated thermistor is coupled to a top of winding of a voice coil in a voice coil assembly. The glass encapsulated thermistor is coupled to the top by adhesive. The glass encapsulated thermistor and its components are non-ferromagnetic so that there is no electromagnetic interaction between the voice coil winding and the magnetic flux gap of the voice coil assembly. Accordingly, the glass encapsulated thermistor is able to sense a change in temperature without impacting any of the electromagnetism of the voice coil winding and the magnetic flux gap.

Advantageously, while the glass encapsulated thermistor is predominately used in corrosive/dangerous and/or extreme temperature environments, and a speaker is not such an environment, the illustrated utilization of the glass encapsulated thermistor outside of its usual context allows for direct measurement of voice coil temperature that hitherto has been unworkable with existing sensors. The glass encapsulated thermistor, because of its peculiar properties, is able to perform its function without distorting, disrupting, or damaging operation of the speaker. Further, the glass encapsulated thermistor is easily coupled to the voice coil assembly by adhesive, or other curable materials, during manufacturing.

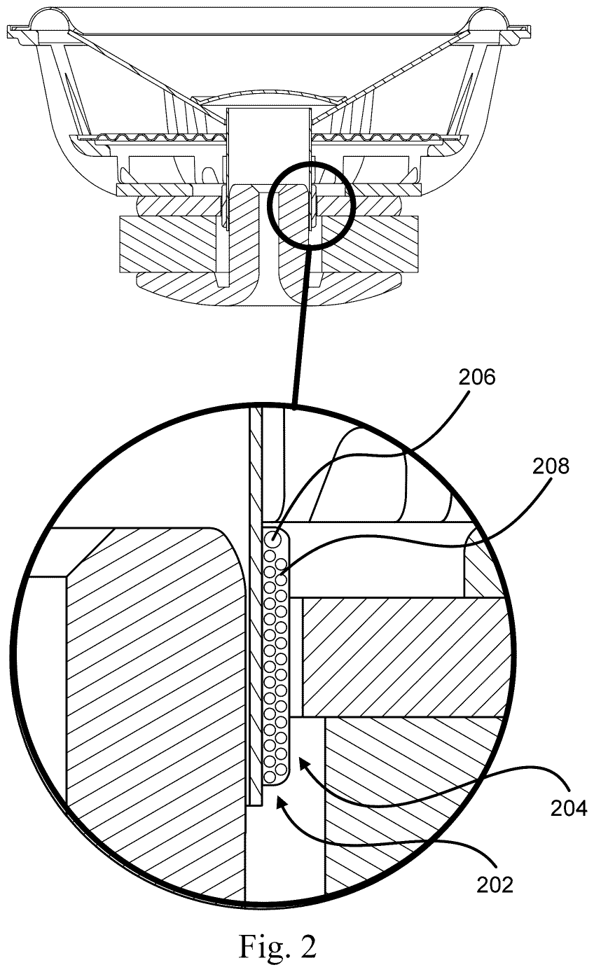

FIG. 2 illustrates a magnified/close-up side sectional view of a voice coil assembly, according to one embodiment of the invention. As illustrated, there is a voice coil 202 including voice coil winding 204. A glass encapsulated thermistor 206 is coupled to the voice coil winding 204 by adhesive 208.

As shown, the glass encapsulated thermistor 206 is coupled to the voice coil winding 204 by adhesive 208 disposed throughout the voice coil winding 204 and between the voice coil winding 204 and the glass encapsulated thermistor 206. The adhesive 208 may be any substance used for sticking objects or materials together such as glue, bonder, epoxy, resin, and other curable or heat-treatable bonding substances. The adhesive 208 may of a type that be cured and/or able to withstand high temperatures. More, the adhesive 208 may physically and thermally couple the glass encapsulated thermistor 206 to the voice coil winding 204, such that the adhesive 208 may attach the glass encapsulated thermistor 206 to the voice coil winding 204 and allow for temperature changes to be transferred from the voice coil winding 204 to the glass encapsulated thermistor 206. Accordingly, it is understood that the adhesive 208 may be such as the Voice Coil Bonder 360, by Hernon Manufacturing, 121 Tech Drive, Sanford, FL. 32771.

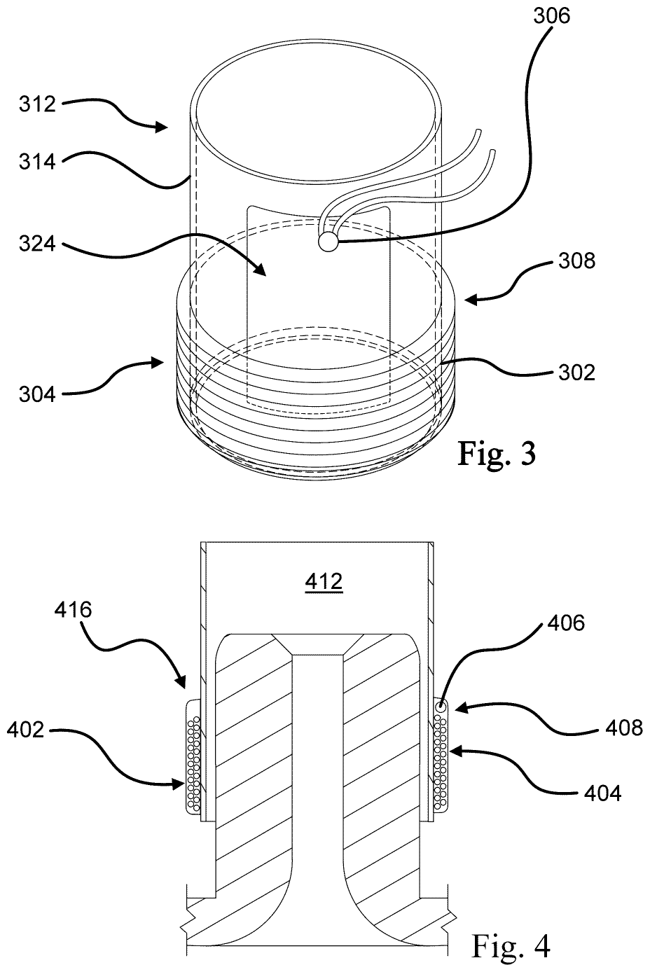

FIG. 3 illustrates a front perspective sectional view of a voice coil assembly, according to one embodiment of the invention. There is shown, a voice coil 302 having voice coil winding 304. A glass encapsulated thermistor 306 is shown disposed along a top 308 of the voice coil winding 304. In addition, the voice coil 302 is formed around a voice coil former 312, with the glass encapsulated thermistor 306 disposed on an exterior surface 314 of the voice coil former 312. A thermally conductive strip 324 is also shown, disposed between the glass encapsulated thermistor 306 and the voice coil winding 304.

As illustrated, the voice coil former 312 is disposed interior to the voice coil winding 304. The voice coil former 312 also provides support to the voice coil winding 304 and helps shape the voice coil 302. The voice coil winding 304 is wound about the voice coil former 312 such that the voice coil former 312 functions as a bobbin for winding and forming the voice coil 302.

The illustrated voice coil former 312 has a cylindrical or tubular shape; however, it is understood that the voice coil former 312 may have any shape or size for forming a voice coil 302 and allowing for voice coil winding 304. In one embodiment, the former 312 may be a rigid cylinder around which the voice coil 302 is wrapped, thus maintain a circular shape of the voice coil winding 304. In addition, the former 312 may be combined with an inside ring of a diaphragm of a speaker, which may be centered by a driver surround or a spider suspension system.

In one embodiment, the glass encapsulated thermistor 306 may be disposed on an exterior surface 314 of the voice coil former 312 adjacent to a top 308 of the voice coil winding 304. In another embodiment, the glass encapsulated thermistor 306 may be disposed on an interior surface of the voice coil former 312 and/or a bottom of the voice coil winding 304. Accordingly, it is understood that the glass encapsulated thermistor 306 may be disposed anywhere near the voice coil 302 for reading temperatures of the voice coil 302.

Further shown, there is a thermally conductive strip 324 that is disposed between the glass encapsulated thermistor 306 and the voice coil winding 304 on the voice coil former 312. The thermally conductive strip 324 may be a strip or portion of any material for conducting heat to the glass encapsulated thermistor 306. For instance, the thermally conductive strip 324 may be comprised of materials such as but not limited to: copper, aluminum, gold, silver, and iron, or a composite assembly like a heat pipe. The thermally conductive strip 324 may be adhered to the voice coil former 312 with the glass encapsulated thermistor 306, or the thermally conductive strip 324 may be held in place on the voice coil former 312 by the voice coil winding 304. Accordingly, the thermally conductive strip 324 may assist the glass encapsulated thermistor 306 with sensing changes in temperature.

FIG. 4 illustrates a side sectional view of a voice coil assembly, according to one embodiment of the invention. There is illustrated, a voice coil 402 having voice coil winding 404. Also illustrated, a glass encapsulated thermistor 406 is coupled to a top 408 of the voice coil winding 404 and a counter-weight 416 is coupled to a top 408 of the voice coil winding 404 opposite the glass encapsulated thermistor 406.

As shown, the counter-weight 416 is disposed on the voice coil former 412 opposite to the glass encapsulated thermistor 406. The counter-weight 416 is a weight that, by applying an opposite force, provides balance and stability to the mechanical system. The counter weight 416 may be comprised of materials such as but not limited to glass, metal, or extra adhesive. It is also understood that a single counter-weight 416 or a plurality of counter-weights may placed along the voice coil assembly according to a desired center of mass. Accordingly, the counter-weight 416 allows for the center of mass of the voice coil assembly to be unaltered by a mass of the glass encapsulated thermistor 406.

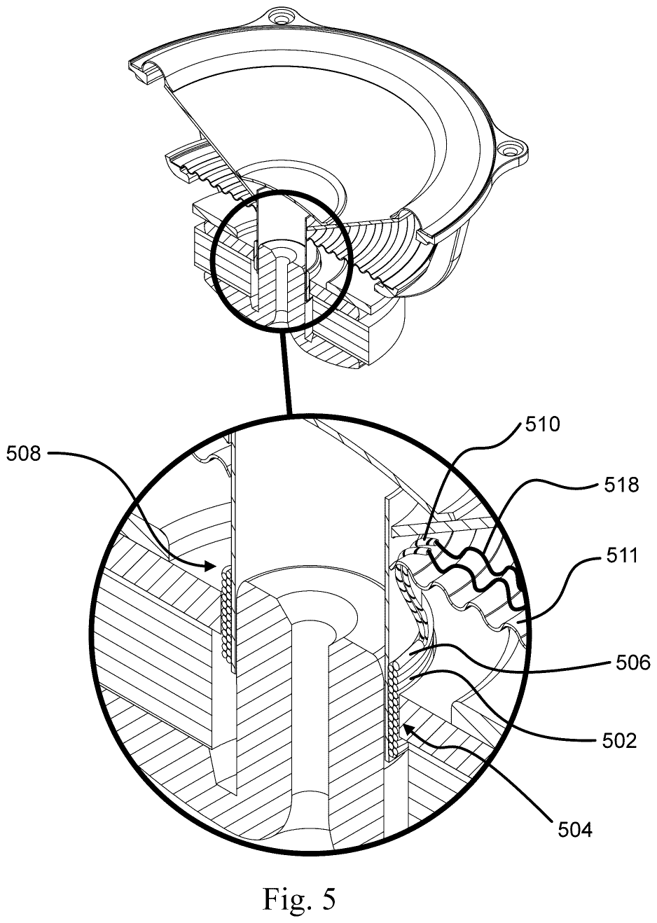

FIG. 5 illustrates a magnified/close-up front perspective sectional view of a voice coil assembly, according to one embodiment of the invention. As shown, the voice coil assembly includes a voice coil 502 with voice coil winding 504. A glass encapsulated thermistor 506 is coupled to the voice coil winding 504 at a top 508 of the voice coil winding 504. The glass encapsulated thermistor 506 also includes lead wires 510 with tinsel leads 518 coupled thereto.

The illustrated glass encapsulated thermistor 506 is coupled to the voice coil winding 504. The glass encapsulated thermistor 506 is in thermal contact with the voice coil winding 504 so that the glass encapsulated thermistor 506 is able to sense and measure heat from the voice coil winding 504, but the glass encapsulated thermistor 506 is not directly electrically coupled to the voice coil 502 so that the glass encapsulated thermistor 506 and the voice coil 502 run on different circuits. For example, the glass encapsulated thermistor 506 may be in physical contact, but may not be in electrical communication, with the voice coil 502. In another embodiment, the glass encapsulated thermistor 506 may be indirectly electrically coupled to the voice coil 502 such that a modulating or processing circuit is disposed between the glass encapsulated thermistor 506 and the voice coil 502.

The illustrated glass encapsulated thermistor 506 is also coupled to lead wires 510 that extend from the glass encapsulated thermistor 506 opposite the voice coil 502. The illustrated lead wires 510 are functionally coupled to tinsel leads 518 such that a signal may be sent from the glass encapsulated thermistor 506 through the lead wires 510 and through the tinsel leads 518. As shown, the tinsel leads 518 rest atop a spider 511 that helps protect and secure the tinsel leads 518.

The tinsel leads 518 may be comprised of tinsel wire or a type of electrical wire used for applications that require high mechanical flexibility but low current-carrying capacity. The tinsel leads 518 may be constructed by wrapping several strands of thin metal foil about a flexible nylon or textile core. Because a tinsel lead 518 may be very thin, the bend radius imposed on the tinsel lead 518 may be much greater than the thickness of the tinsel lead 518, leading to a low probability of metal fatigue. Also, the core of the tinsel lead 518 may provide a high tensile strength without impairing flexibility.

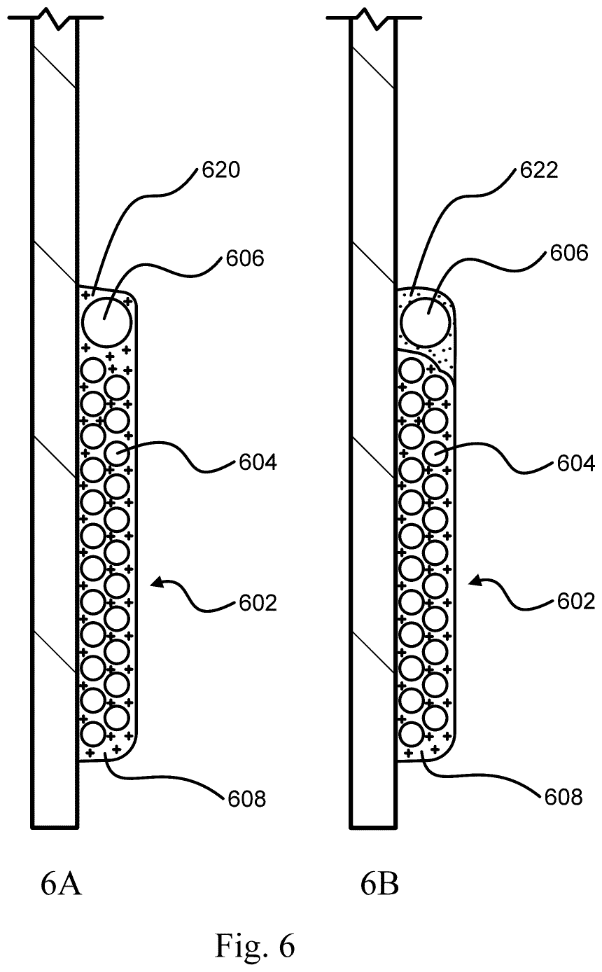

FIGS. 6A and 6B illustrates a side sectional view of a voice coil assembly, according to one embodiment of the invention. As illustrated, there is a voice coil 602 including voice coil winding 604. A glass encapsulated thermistor 606 is coupled to the voice coil 602 by adhesive 608. The adhesive 608 may be a unitary adhesive 620 or a separate adhesive 622.

As shown, there is a unitary adhesive 620 that couples the glass encapsulated thermistor 606 to the voice coil winding 604. The unitary adhesive 620 may be unitary with the adhesive 608 so that they are comprised of the same material and/or so that they are cured at the same time during assembly. There is also shown a separate adhesive 622 that may alternatively couple the glass encapsulated thermistor 606 to the voice coil winding 604. The separate adhesive 622 may be separate from the adhesive 608 so that they are comprised of a different material and/or so that they are cured at a different time during assembly.

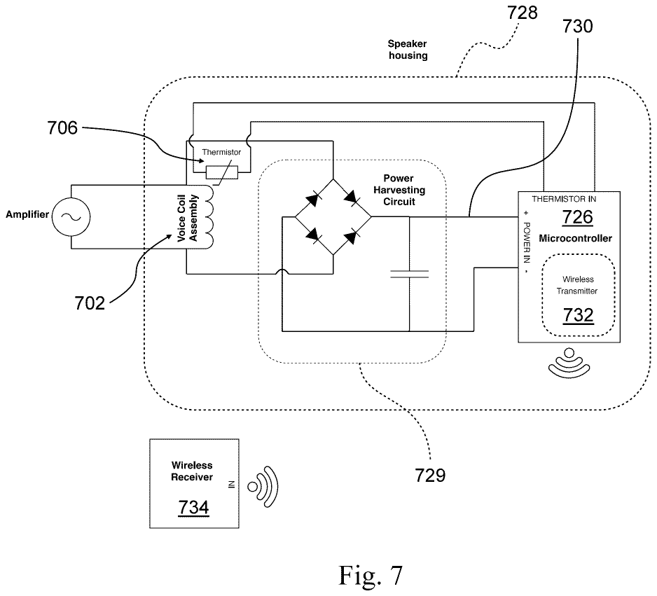

FIG. 7 illustrates a circuit diagram of a voice coil assembly, according to one embodiment of the invention. As shown, there is a voice coil 702 disposed within a speaker housing 728. A glass encapsulated thermistor 706 is coupled to the voice coil 702, in direct thermal contact with the voice coil 702. A microcontroller 726, also disposed within the speaker housing 728, includes a wireless transmitter, and is in signal communication with the glass encapsulated thermistor 706. A power harvesting circuit 729 is functionally coupled to the microcontroller 726 and is disposed within the speaker housing 728.

The illustrated microcontroller 726 is in signal communication with the glass encapsulated thermistor 706 to receive information therefrom. It is understood that the microcontroller 726 is generally a compact, integrated circuit designed to govern a specific operation in an embedded system. For example, the microcontroller 726 may be such as the Arduino Uno Rev 3, by Arduino S.r.l., with registered office in via Andrea Appiani 25, 20900 Monza (MB), Italy, which is incorporated by reference herein.

Further, the illustrated microcontroller 726 includes a wireless transmitter 732. In one embodiment, the wireless transmitter 732 may be a transmitter 732 that sends its signal to the receiver (e.g., the wireless receiver 734) without wires between them. For example, the wireless transmitter 732 may include wireless transmission such as a radio transmitter, a tv transmitter, a garage door opener, WIFI, a radar transmitter, Bluetooth, cell phones, and so on.

The illustrated power harvesting circuit 729 is functionally coupled to the microcontroller 726. The illustrated power harvesting circuit 729 is also electrically coupled to the voice coil 702. In one embodiment, the power harvesting circuit 729 may be functionally coupled to the microcontroller 726 by electrical coupling. The power harvesting circuit 729 may also be functionally coupled to an ohmmeter and/or a signal generator. The illustrated power harvesting circuit 729 is configured to capture and convert environmental energy into electrical energy and feed the electrical energy to the microcontroller 726. The power harvesting circuit 729 may be used to capture and convert any kind of available environmental energy (kinetic energy, ambient energy, thermal energy, etc.) into electrical energy.

The illustrated power harvesting circuit 729 includes an output line 730 that is not electrically coupled to the voice coil 702. The output line 730 transfers captured energy. Accordingly, in operation of the illustrated embodiment, the power harvesting circuit 729 harvests electrical energy from the voice coil 702. Then, the power harvesting circuit 729 may transfer captured energy to the microcontroller 726, which in turn may transfer energy to the thermistor 706 or to another device for use or for storage.

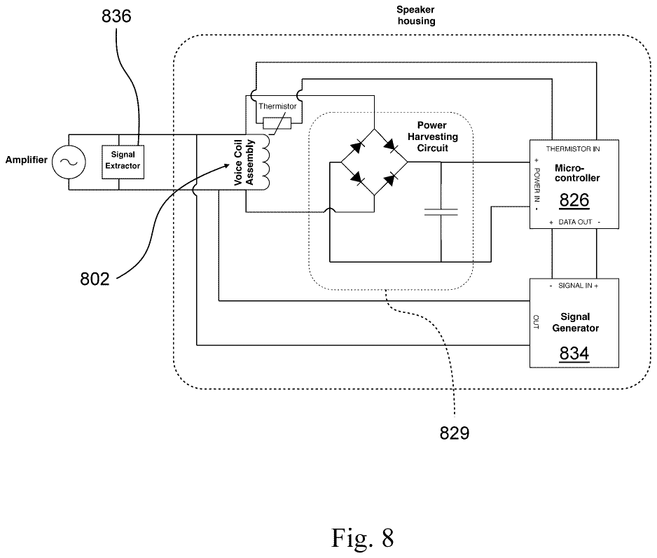

FIG. 8 illustrates a circuit diagram of a voice coil assembly, according to one embodiment of the invention. As illustrated, the voice coil assembly includes a signal generating circuit 834 in communication with the microcontroller 826. The illustrated signal generating circuit 834 is also electrically coupled to the voice coil 802. In addition, there is a power harvesting circuit 829 in communication with the microcontroller 826.

The illustrated power harvesting circuit 829 is functionally coupled to the microcontroller 826. The power harvesting circuit 829 is also electrically coupled to the voice coil 802. In one embodiment, the power harvesting circuit 829 may be functionally coupled to the microcontroller 826 by electrical coupling. The power harvesting circuit 829 may also be functionally coupled to another component of the voice coil assembly. The power harvesting circuit 829 harvests electrical energy from the voice coil 802. The power harvesting circuit 829 transfers captured energy to the microcontroller 826, which in turn may transfer energy to a thermistor or to another component of the assembly.

The illustrated signal generating circuit 834 generates signals based on information from the microcontroller 826 that may be transmitted through the voice coil 802 and to the signal extractor 836. Thereby, temperature information and other operational parameters may be accessible outside of the speaker. According to one embodiment of the invention, the voice coil 802 may have an intended frequency range, and the signal generating circuit 834 may generate a signal that is outside the intended frequency range of the voice coil 802. For example, in one non-limiting embodiment, the signal generating circuit 834 may generate a signal with a carrier frequency that is outside the frequency range of between about twenty hertz to twenty kilohertz (a range that is the recognized audio range for human hearing). Further, the signal generating circuit 834 is electrically coupled to the voice coil 802 so that the signal generating circuit 834 sends a signal out through the voice coil 802 and the signal is received by the signal extractor 836.

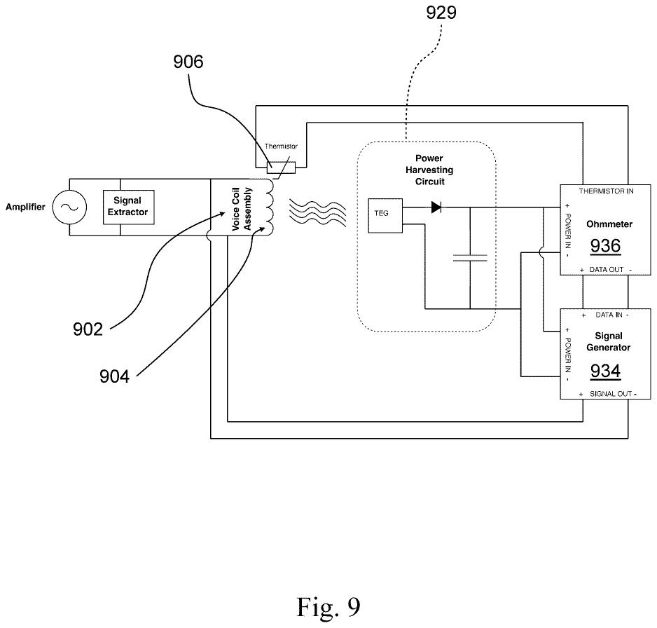

FIG. 9 illustrates a circuit diagram of a voice coil assembly, according to one embodiment of the invention. As shown, there is a voice coil 902 with voice coil winding 904. A glass encapsulated thermistor 906 is coupled to the voice coil winding 904, in direct thermal contact with the voice coil winding 904. An ohmmeter 936 is functionally coupled to the glass encapsulated thermistor 906, and a signal generator 934 is in communication with the ohmmeter 936 and electrically coupled to the voice coil 902. There is also illustrated a power harvesting circuit 929 functionally coupled to at least one of the ohmmeter 936 and the signal generator 934.

The illustrated signal generator 934 generates signals based on information from the ohmmeter 936 that may be transmitted through the voice coil 902 and to the signal extractor. The signal generator 934 may be as simple as an oscillator with calibrated frequency and amplitude (e.g., wherein the signal is turned on/off based on temperature thresholds observed by the ohmmeter 936). The signal generator 934 may include a signal generating circuit (see e.g. FIG. 8, item 834) or one of a class of electronic devices that generates electrical signals with set properties of amplitude, frequency, and wave shape. The signal generator 934 generates signals that may be transmitted through the voice coil winding 904 and received by the signal extractor.

According to one embodiment, the voice coil 902 may have an intended frequency range. The signal generator 934 may generate a signal representing temperature information. The signal generator 934 may generate a signal that is outside the intended frequency range of the voice coil 902. For example, in one non-limiting embodiment, the signal generator 934 may generate a signal with a carrier frequency that is outside the frequency range of between about twenty hertz to twenty kilohertz (a range that is the recognized audio range for human hearing).

The signal generator 934 is also in communication with the ohmmeter 936. The ohmmeter 936 is an instrument for measuring electrical resistance, which is expressed in ohms. In one embodiment, the ohmmeter 936 may such as the Mi3250 MicroOhm 10A, by Metrel d.o.o., Ljubljanska c. 77, SI-1354 Horjul, Slovenia, which is incorporated by reference herein.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Finally, it is envisioned that the components of the device may be constructed of a variety of materials such as but not limited to: wood, metal, plastic, and composite.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A voice coil assembly, comprising:
a. a voice coil including voice coil winding;
b. a glass encapsulated thermistor, coupled to the voice coil winding, in direct thermal contact with the voice coil winding, and not electrically coupled to the voice coil; and
c. adhesive, disposed between the voice coil winding and the glass encapsulated thermistor, physically and thermally coupling the glass encapsulated thermistor to the voice coil winding.

2. The voice coil assembly of claim 1, wherein the glass encapsulated thermistor is coupled to a top of the voice coil winding.

3. The voice coil assembly of claim 1, wherein the glass encapsulated thermistor includes a lead wire and wherein the lead wire consists of non-ferromagnetic material.

4. The voice coil assembly of claim 1, further comprising a voice coil former interior to the voice coil winding, wherein the glass encapsulated thermistor is disposed on an exterior surface of the voice coil former and adjacent to the voice coil winding.

5. The voice coil assembly of claim 1, further comprising a counter-weight disposed opposite to the glass encapsulated thermistor, such that the center of mass of the voice coil assembly is not altered by the glass encapsulated thermistor.

6. The voice coil assembly of claim 1, further comprising tinsel leads functionally coupled to lead wires of the glass encapsulated thermistor.

7. The voice coil assembly of claim 1, wherein the glass encapsulated thermistor has an operating temperature range including between negative twenty degrees Celsius to two hundred and sixty degrees Celsius.

8. The voice coil assembly of claim 1, wherein the adhesive is unitary with adhesive of the voice coil winding because during assembly the adhesive and the adhesive of the voice coil winding were cured at the same time.

9. A voice coil assembly, comprising:
a. a voice coil including voice coil winding disposed about a voice coil former; and
b. a glass encapsulated thermistor, coupled to the voice coil winding, in thermal contact with the voice coil winding, and not directly electrically coupled to the voice coil, wherein the glass encapsulated thermistor includes a lead wire and wherein the lead wire consists of non-ferromagnetic material.

10. The voice coil assembly of claim 9, further comprising a thermally conductive strip disposed between the glass encapsulated thermistor and the voice coil winding.

11. The voice coil assembly of claim 9, wherein the thermistor includes a single glass encapsulated bead in direct thermal contact with the voice coil winding.

12. The voice coil assembly of claim 9, further comprising:
a. a microcontroller in signal communication with the glass encapsulated thermistor; and
b. a power harvesting circuit functionally coupled to the microcontroller, configured to capture and convert environmental energy into electrical energy and feed the electrical energy into the microcontroller.

13. A voice coil assembly, comprising:
a. a speaker housing;
b. a voice coil disposed within the speaker housing;
c. a glass encapsulated thermistor, coupled to the voice coil, in direct thermal contact with the voice coil;
d. a microcontroller in signal communication with the glass encapsulated thermistor disposed within the speaker housing; and
e. a power harvesting circuit functionally coupled to the microcontroller and disposed within the speaker housing, configured to capture and convert environmental energy into electrical energy and feed the electrical energy into the microcontroller.

14. The voice coil assembly of claim 13, wherein the power harvesting circuit is electrically coupled to the voice coil.

15. The voice coil assembly of claim 13, wherein the microcontroller includes an output line not electrically coupled to the voice coil.

16. The voice coil assembly of claim 13, wherein the microcontroller includes a wireless transmitter.

17. The voice coil assembly of claim 13, wherein the voice coil has an intended frequency range and further comprising a signal generating circuit in communication with the microcontroller and electrically coupled to the voice coil, wherein the signal generating circuit generates a signal representing temperature information and the signal is outside of the intended frequency range.

18. A voice coil assembly, comprising:
a. a voice coil winding;
b. a glass encapsulated thermistor, coupled to the voice coil winding, in direct thermal contact with the voice coil winding;
c. an ohmmeter functionally coupled to the glass encapsulated thermistor; and
d. a signal generator in communication with the ohmmeter and electrically coupled to the voice coil such that a signal generated thereby is transmitted through the voice coil winding.

19. The voice coil assembly of claim 18, further comprising a power harvesting circuit functionally coupled to at least one of the ohmmeter and the signal generator, configured to capture and convert environmental energy into electrical energy and feed the electrical energy thereinto.

20. The voice coil assembly of claim 18, wherein the signal generator generates a signal with a carrier frequency that is outside the frequency range of between about twenty hertz to twenty kilohertz.

21. The voice coil assembly of claim 18, further comprising a voice coil former interior to the voice coil winding, wherein:
a. the glass encapsulated thermistor is disposed on an exterior surface of the voice coil former and adjacent to the voice coil winding;
b. the glass encapsulated thermistor is coupled to a top of the voice coil winding; and
c. the glass encapsulated thermistor includes a lead wire and wherein the lead wire consists of non-ferromagnetic material.
